(19) United States
(12) Patent Application Publication
(10) Pub. No.: US 2009/0047385 A1
(43) Pub. Date: Feb. 19, 2009

(54) NATURAL OAT-DERIVED SWEETENER

(75) Inventors: James D. Hansa, Algonquin, IL (US); Richard N. McArdle, Palatine, IL (US)

Correspondence Address: BANNER & WITCOFF, LTD.;and ATTORNEYS FOR CLIENT NO. 006943, 10 SOUTH WACKER DR., SUITE 3000, CHICAGO, IL, 60606, US

(73) Assignee: THE QUAKER OATS COMPANY, Chicago, IL (US)

(21) Appl. No.: 11/839,428

(22) Filed: Aug. 15, 2007

(51) Int. Cl. A23L 1/105; A23L 1/10; A23L 1/168

(52) U.S. Cl. 426/28; 426/618; 426/619

(57) ABSTRACT

An oat-derived sweetener and methods related thereto are provided. The use of an oat-derived sweetening ingredient allows for the masking of off flavors and sweetening without the use of sugar, sucralose and acesulfame potassium or other sweetening agents that are perceived as being unhealthy. The oat-derived sweetener can be utilized in a number of food products and beverages, including oatmeal.

### FIELD OF THE INVENTION

The present invention relates generally to natural sweeteners. More particularly the present invention relates to natural sweeteners formed by processing oats. Even more particularly, the present invention relates to the enzymatic modification of oats in order to derive a sweetener.

### BACKGROUND

Oatmeal has for many years been a staple of the human diet due to its health benefits. For example, numerous studies have shown that eating oatmeal on a daily basis can help lower blood cholesterol, reduce risk of heart disease, promote healthy blood flow, as well as maintain healthy blood pressure levels. Additionally, oatmeal has high content of complex carbohydrates and fibers, which facilitates slow digestion and stable blood-glucose levels.

To make oatmeal more palatable, artificial sweeteners are typically added. Oatmeal can be sweetened using sucrose or sucrose substitutes, such as sucralose and acesulfame potassium. Sucralose can be anywhere from 300-1000 times as sweet as sucrose and other artificial sweeteners, such as acesulfame potassium, can be from 180-200 times sweeter than sucrose. These sweeteners are also useful to mask off-flavors inherently found in oats.

Artificial sweeteners, however, suffer from many disadvantages. One disadvantage of acesulfame potassium, for example, is that acesulfame potassium has its own slightly bitter aftertaste. As such, the addition of acesulfame potassium in order to mask off-flavors of oats can be counter-productive. To resolve this problem, it is commonly understood to blend other artificial sweeteners with acesulfame potassium in order to mask the aftertaste. In addition, the use of such sweeteners tends to make the product less attractive to health conscious consumers, since they are not perceived as being healthy for consumption.

It would therefore be desirable to provide a sweetener for which is perceived to be healthy for consumption. It would also be desirable to provide a sweetener that is a naturally derived product.

### SUMMARY

In accordance with aspects of the invention, a method for deriving a sweetener from oats is provided. The method includes generating an oat component and hydrolyzing the oat component with enzyme to form a modified oat flour. The modified out flour is dried to provide a sweetener composition, and the sweetener composition is granulated to form a sweetener. The oat component may include whole oat groats, oat flour, rolled oats, partially milled oats, oatmeal, or combinations thereof. The enzyme may be glycoside hydrolase enzyme. The glycoside hydrolase enzyme may be selected from the group consisting of α-Amylase, β-Amylase, γ-Amylase, acid α-glucosidase and combinations thereof.

In accordance with other aspects of the invention, a process for deriving a natural sweetener from oats is provided. The process includes providing a starting material including an oat component and adding water to the starting material to form a mixture. The mixture can be pre-processed. If necessary, the mixture is hydrolyzed with an enzyme to form an oat composition. The oat composition is dried to form a sweetener. The oat component may include whole oat groats, oat flour, rolled oats, partially milled oats, oatmeal, or combinations thereof. Pre-processing may include cooking the mixture. The mixture may be hydrolyzed using a hydrolase enzyme that is able to catalyze the hydrolysis of the alpha-glucosidic bonds in starch. The hydrolase enzyme may be a glucosidase. The glucosidase may be selected from the group consisting of alpha-amylase, beta-amylase or combinations thereof.

In accordance with still further aspects of the invention, a sweetener that is naturally derived from oats is provided. In certain aspects, an oat component is enzymatically modified to result in an oat component that is self-sweetened.

Still further aspects of the invention include sweeteners that are derived from oats that are particulate based. The sweeteners may also be granulated or powder based, depending on the use of the particulate.

In accordance with other aspects of the present invention, self-sweetened food products are provided. Self-sweetened food products can be obtained by hydrolyzing a grain component with an enzyme to form a hydrolyzed grain composition. The hydrolyzed grain composition is allowed to achieve a desired degree of hydrolysis. Once the desired degree of hydrolysis has been achieved, the hydrolyzed grain composition can be heated. Heating the hydrolyzed grain composition will inhibit certain enzyme activity. After heating, the hydrolyzed grain composition can be dried out in order to form a self-sweetened food product. In some aspects of the invention, the self-sweetened food product is oatmeal.

### DETAILED DESCRIPTION

A natural sweetener derived from a cereal grain and the like is provided. A variety of cereal grain, such as oat, barley, rice, wheat, maize, rye, sorghum, triticale or millet, or combinations thereof, can be used. In certain aspects, the natural sweetener is derived from oat. Oat soluble fibers, such as beta glucan, have been found to contribute to the reduction of cholesterol, among other effects. As such, it is advantageous to utilize a cereal grain that also includes beta glucan. Moreover, oats are preferably gelatinized prior to use. Gelatinization is typically a cooking process in which the hard kernel coating is broken and the starch granules are ruptured and released.

Natural sweeteners can be used as sweetening agents for grain-based food products. For example, grain-based food products include cereal grain such as oat, wheat, corn (maize), rice, barley, millet, sorghum (milo), rye, triticale, teff, wild rice, spelt, buckwheat, amaranth, quinoa, ka\ddot{n}iwa, cockscomb, or combinations thereof (e.g., multi-grain). Food products such as cereal grain-based or non-cereal grain-based food product which are provided in instant, non-instant, or semi-instant forms and include the natural sweeteners are also contemplated as being within the scope of the invention. For example, the grain-based food product may include instant oatmeal. The natural sweeteners also can be used in other types of food products and also beverages.

The natural sweetener is sufficiently sweet to allow it to be used as a supplement or replacement for sweeteners, such as sucrose or sucrose substitutes, which are conventionally added to grain-based food products.

The sweetener is derived from a natural starting material. In certain aspects, the starting material includes oat or its derivative (“oat component”). Other types of cereal grain may also be used. The oat component can be provided in various forms, including whole oat groats, oat flour, rolled oats, partially milled oats, oatmeal, or combinations thereof.

The oat component may be subjected to pre-processing to form a starch-containing mixture. It is also contemplated that certain oat components may not require any degree of pre-processing to form the starch-containing mixture. The pre-processing procedure may differ depending on the form in which the oat component is provided. For example, whole oat groats may be crushed or ground between rollers to produce oat flakes. The crushed oat grains or oat flakes may be further subjected to wet or dry milling to produce oat flour. The oat component also may be milled to fine granulation to facilitate water, heat and enzyme penetration in subsequent processing steps. In certain aspects, the oat component is provided in wet form rather than dry form. The wet form is sometimes preferred because in some instances, additional drying may cause the development of rancidity. The wet form is preferred in some instances because it accelerates conversion of starch to sugar time through better combining of the substrate and the enzyme.

The oat component is milled to particle sizes of 6.35 μm, 125 μm and/or 420 μm. After milling, separation techniques, such as screening, can be used to isolate over-sized particles for removal. Other separation techniques known to those of skill in the art may also be employed, including, but not limited to, filtration techniques.

The oat component is mixed with an amount of liquid, such as water, to form a mixture. The mixture comprises at least about 5-40, including 18-25, weight % [wt %] solid on a dry matter basis, depending on the hydration technique. The level of solids within the mixture can be adjusted to control the sweetness level of the natural sweetener. For example, increasing the level of solids increases the starch content of the mixture, which in turn increases the sweetness of the natural sweetener.

The mixture can be processed. It will be understood by those of ordinary skill in the art that processing is a step that may or may not be necessary in every instance depending on the chosen application for the naturally derived sweetener. For example, the processing may include cooking the mixture. Cooking processes involve subjecting the mixture to high temperatures, which preferably effects at least partial gelatinization of the starch contained in the mixture. In certain aspects, substantially all of the starch in the mixture can be gelatinized in the cooking step. The degree of gelatinization can vary depending on the use of the final product. High temperatures during cooking also serve to inactivate enzymes, such as lipase and peroxidase, inherent in oats. These enzymes could potentially favorably affect the taste of the natural sweetener by promoting lipid oxidation.

Various conventional methods can be used to cook the mixture. Such methods include, for example, direct and indirect steam heating, through steam injection in a jet cooker or plate heat exchanger, scrape surface heat exchanger, cooking in a pressure chamber, such as an autoclave or rotary cooker, or an extruder. Other cooking techniques may also be useful as would be appreciated by those of ordinary skill in the art. The cooking temperature is maintained below 160-300° F., for example, below 160° F. to minimize off-flavors that may be produced from reactions of non-starch components, such as proteins or fats, in the oat component. The level of solids in the mixture may be adjusted after cooking, for example by adding more liquid.

Thereafter, if desired, the mixture is subjected to an enzymatic hydrolysis to produce a hydrolyzed oat composition. The starches and polysaccharides of the mixture are converted into simpler sugars by the action of enzymes. In general, any hydrolase enzyme able to catalyze the hydrolysis of the α-glucosidic bonds in starch can be used. Useful enzymes include glucosidases, including, for example, α-amylase and β-amylase. It is contemplated that many enzymes could be utilized in provided that there is minimal or no beta glucanese side activity. Other enzymes are also contemplated for use as would be appreciated by those having ordinary skill in the art. α-amylase and β-amylase convert starch to maltodextrin and maltose, respectively, while glucosidase produces glucose. Isomerase enzymes, for catalyzing the interconversion of isomers, may also be useful. An example is glucose isomerase, which catalyzes the conversion of glucose into fructose. Suitable commercially available enzymes include, for example, from Kerry Bioscience, Novo-Nordisk and Genentech.

One or more of enzymes may be used for catalyzing the hydrolysis of the starch contained in the mixture. By using a combination of enzymes, various ratios of different monosaccharides or disaccharides can be produced. The enzymes can be introduced to the mixture either simultaneously or in sequence, according to the desired saccharide profile of the natural sweetener, which in turn affects its sweetness and taste. As an example, it is contemplated that in some instances, the enzyme will be placed in solution, followed by the addition of ½ of the oat concentration. Once the viscosity of the solution decreases, the other ½ of the oat concentration can be added.

In certain aspects, hydrolysis is carried out in a mixing kettle, mixer or an extruder. Various types of conventional mixers or extruders can be used as would be appreciated by those of ordinary skill in the art. For example, mixers and extruders made by Clextral, Werner-Pflieder, Wenger, Cherry-Burrell can be used. The mixture is fed to the mixer along with the selected enzyme(s). Free enzymes are introduced directly into the mixture. In other aspects, the mixture is introduced to a vessel or reactor containing immobilized enzymes. Unlike free enzymes, which are typically not reused owing to problems and high costs associated with recovery, immobilized enzymes can be reused and recovered. Enzymatic performance is highly sensitive to process conditions such as temperature and pH. For example, temperature affects catalytic activity while pH can influence the product spectra. Reaction time determines the degree of degradation and thus also affects the product spectra. For example, the hydrolysis step may be conducted anywhere from 5 to 120 minutes.

The degree of hydrolysis is related to the sweetness level of the natural sweetener. In general, sweetness level increases with the amount of starch hydrolyzed. The enzyme level utilized for the degree of hydrolysis is about 0.01% to about 1% by weight. After the starch is sufficiently hydrolyzed, the hydrolysis process is terminated. The resultant hydrolyzed oat composition can be heated to about 150-300° F. to deactivate the enzymes, thus stopping their action. Other methods including, for example, centrifugation, chromatographic techniques, or separation of the mixture from the immobilized enzymes, may also be useful. Alternatively, the same effect can be achieved by cooling the hydrolyzed oat composition. In certain aspects, the resultant hydrolyzed oat composition has a Dextrose Equivalent (DE) value of about 10-90.

The hydrolyzed oat composition is filtered to separate non-soluble starches or other components for removal. Filtration can be accomplished by various conventional techniques as would be appreciated by those having ordinary skill in the art. Other methods for removing insoluble components, including centrifuging or decanting, may also be useful. Depending on the use of the natural sweetener, the hydrolyzed oat composition may also be sterilized, for example, by subjecting it to an ultra high temperature treatment at about 270° F. for about 30 minutes.

Once hydrolyzed, the hydrolyzed oat composition is dried to produce a natural sweetener. Various conventional techniques can be used for drying as would be appreciated by those having ordinary skill in the art. Such techniques include, for example, roller drying, freeze drying, lyophilization, spray-drying, drum drying, refractance drying, flash drying, fluidized bed drying, and the like.

The dried natural sweetener can be processed for use. In certain aspects, the dried natural sweetener can by used for self-sweetening food products. In addition, the dried natural sweetener can be added to other food products. For example, the sweetener can be further processed to be granulated and/or powdered. The natural sweetener is useful for replacing conventional sweeteners, such as sucrose or sucrose substitutes, in grain-based food products. Use of the natural sweetener may make such products more attractive to health-conscious consumers.

It is contemplated that the naturally derived self-sweetened compositions in accordance with the teachings of the present invention can be used in a number of food products and beverages. For example, it is contemplated that the natural sweeteners can be used in oatmeal and other ready-to-eat cereals, beverages and puddings, among other uses as would be appreciated by those of ordinary skill in the art.

The foregoing embodiments are to be considered in all respects illustrative rather than limiting the invention described herein. The invention has been described with reference to certain preferred embodiments. Obviously, modifications and alterations will occur to others upon reading and understanding the preceding detailed description. It is intended that the invention be construed as including all such modifications and alterations insofar as they come within the scope of the appended claims or the equivalents thereof.

What is claimed is:

1. A method of deriving a sweetener from oats comprising:
providing an oat component;
hydrolyzing the oat component with enzyme to form a modified oat flour; drying the modified oat flour to provide a sweetener composition; and
processing the sweetener composition to form a sweetener.

2. The method of claim 1 wherein the oat component comprises whole oat groats, oat flour, rolled oats, partially milled oats, oatmeal, or combinations thereof.

3. The method of claim 1 wherein the enzyme is glycoside hydrolase enzyme.

4. The method of claim 3 wherein the glycoside hydrolase enzyme is selected from the group consisting of α-Amylase, β-Amylase, γ-Amylase, acid α-glucosidase and combinations thereof.

5. The method of claim 1 wherein the processing of the sweetener composition includes granulation.

6. The method of claim 1 wherein the processing of the sweetener composition includes powderization.

7. A process for deriving a natural sweetener from grains comprising:
providing a starting material including a grain component;
adding liquid to the starting material to form a mixture;
pre-processing the mixture;
hydrolyzing the mixture with an enzyme to form an grain composition; and
drying the grain composition to form a sweetener.

8. The process of claim 7 wherein the grain component includes beta glucan.

9. The process of claim 7 wherein the grain component is barley.

10. The process of claim 7 wherein the grain component comprises whole oat groats, oat flour, rolled oats, partially milled oats, oatmeal, or combinations thereof.

11. The process of claim 7 wherein the pre-processing includes cooking the mixture.

12. The process of claim 7 wherein the mixture is hydrolyzed using a hydrolase enzyme that is able to catalyze the hydrolysis of the alpha-glucosidic bonds in starch.

13. The process of claim 12 wherein the hydrolase enzyme is a glucosidase.

14. The process of claim 13 wherein the glucosidase is selected from the group consisting of alpha-amylase, beta-amylase or combinations thereof.

15. A self-sweetened food product obtained by:
hydrolyzing a grain component with an enzyme to form a hydrolyzed grain composition;
allowing the hydrolysis to continue until a desired degree of hydrolysis is achieved;
heating said hydrolyzed grain composition to inhibit enzyme activity; and
drying said hydrolyzed grain composition to form a self-sweetened food product.

16. The self-sweetened food product of claim 15 wherein said hydrolyzed grain composition is filtered after the desired degree of hydrolysis is achieved.

17. The self-sweetened food product of claim 15 wherein said grain component is an oat component.

18. The self-sweetened food product of claim 15 wherein said grain component is barley.

19. The self-sweetened food product of claim 17 wherein the oat component comprises whole oat groats, oat flour, rolled oats, partially milled oats, oatmeal, or combinations thereof.

20. The self-sweetened food product of claim 17 wherein said food product is oatmeal.

21. The self-sweetened food product of claim 15 wherein the enzyme is a glucosidase.

22. The self-sweetened food product of claim 21 wherein the glucosidase is selected from the group consisting of alpha-amylase, beta-amylase or combinations thereof.
